(19) United States
(12) Patent Application Publication
(10) Pub. No.: US 2005/0058681 A1
(43) Pub. Date: Mar. 17, 2005

(54) Odorless insect repellant and method of use

(76) Inventor: Louis B. Johnson, Troy, AL (US)

Correspondence Address: CLARK & BRODY, 1090 VERMONT AVENUE, NW, SUITE 250, WASHINGTON, DC, 20005, US

(21) Appl. No.: 10/930,863

(22) Filed: Sep. 1, 2004

Related U.S. Application Data
(60) Provisional application No. 60/502,247, filed on Sep. 12, 2003.

(51) Int. Cl. A01N 25/00; A01N 65/00

(52) U.S. Cl. 424/405; 424/760

(57) ABSTRACT

An odorless and all natural insect repellant composition comprises effective amounts of active ingredients as an odorless oil, pepper, and optionally sulfur and diatomaceous earth for insect repellency. The composition also includes effective amounts of one or more emulsifiers for emulsifying components of the composition, and a skin emollient to enhance acceptance of the product onto a user's skin. The balance of the composition is made up of water.

This application claims priority under 35 USC 119(e) based on provisional patent application 60/502,247 filed on Sep. 12, 2003, which is herein incorporated by reference.

### FIELD OF THE INVENTION

The present invention is directed to an odorless insect repellant, and particularly to an odorless insect repellant that includes effective amounts of an odorless oil, pepper, one or more emulsifiers, a skin emollient, and optional ingredients of diatomaceous earth, a preservative, and sulfur, with the balance water.

### BACKGROUND ART

In the prior art, numerous formulations have been proposed for insect repellency. A number employ artificial ingredients, including chemicals that many users are reluctant to apply directly to their skin.

Another problem with present day insect repellents is the odors that they include. These odors can be an attractant for insects, thus compromising the effectiveness of the particular insect repellant being used.

As such, there is a need to develop improved insect repellants, including those that do not contain harsh or unwanted chemical compounds and/or attract insects at the same time as repelling them. The present invention responds to this need with an insect repelling composition that is both odorless and all natural.

### SUMMARY OF THE INVENTION

A first object of the present invention is an odorless insect repellant composition.

Another object of the invention is an odorless insect repellant composition that is made of all natural ingredients.

One other object of the invention is an improvement in repelling insects through the use of the inventive composition.

Other objects and advantages of the present invention will become apparent as a description proceeds.

In satisfaction of the foregoing objects and advantages, the present invention is directed to an insect repellant composition comprising effective amounts of an odorless oil, one or more emulsifiers, pepper, a skin emollient, and optional components of diatomaceous earth, sulfur, and one or more preservative, each in effective amounts for their intended purposes, with the balance being water.

In one embodiment, the skin emollient is preferably glycerin, and the odorless oil is mineral oil. The one or more emulsifiers can include sodium lauryl sulfate, octyl phenol ethoxylate, guar or xanthan gums, emulsion polymers or the like.

In preferred embodiments, the odorless oil is at least 1% by weight of the composition with a more preferred range of 3-5%. The pepper ranges in up to 0.04% by weight of the composition, with a more preferred range of between 0.01 and 0.03%. The skin emollient ranges from 0.05% to 1.0% by weight of the composition with a more preferred range of 0.075 to 0.15%. The emulsifier ranges from 1.0 to 5.0% by weight of the composition, with a more preferred range of 1.5 to 3.0% by weight.

The optional active ingredient of diatomaceous earth can be used in an effective amount for insect repellency, including ranging between about 0.01% by weight and up to 5% by weight. A more preferred range is between about 0.05% and 3% by weight. The optional sulfur ingredient can also be used in an effective amount to deter insects, including a range up to 1.0% by weight of the composition, with a preferred range being between 0.1 and 0.5% by weight. The optional preservative ingredient is also used in effective amounts for preserving the formulation, with preferred ranges including from 0.10 to 1.0% by weight, more preferred ranges being 0.15% to 0.5% with a most preferred target around 0.2-0.3%.

The invention is also an improvement in methods of repelling insects from human skin by application of an insect repellent formulation, whereby the inventive composition is used as the formulation. The application is especially useful in environments where odors of any type are a problem, e.g., hunting environments.

### DESCRIPTION OF THE PREFERRED EMBODIMENTS

The present invention provides a significant advantage in the field of insect repellants by offering an all natural, and odorless repellant. The drawbacks of harmful chemicals are eliminated without compromising the repellent nature of the formulation.

In its broadest embodiment, the invention comprises at least two main active ingredients, an odorless oil and pepper. Each is used in effective amounts to achieve their intended purpose of insect repellency. The invention also includes inert or inactive ingredients as one or more emulsifiers, and a skin emollient, with the balance being water, each also used in effective amounts for their intended purpose. One or more preservatives can also be used. Optional active ingredients include diatomaceous earth and sulfur. The active and inactive ingredients are detailed below.

Active Ingredients:

While the broadest aspect of the invention uses the active ingredients in effective amounts for their intended purposes, the invention also contemplates preferred and more preferred embodiments, wherein the percentages of the active ingredients based on a weight percentage of the total composition are as follows:

Mineral or Other Odorless Oil:

Preferably, the oil is 1.0% to up to an amount that either cannot be sprayed or could not be used in another medium such a cream or lotion, with a more preferred range of 3-5%.

Pepper:

Preferably, the pepper ranges between just above zero to up and 0.04% with a more preferred range being about 0.01-0.03%. Because of the strength of the pepper, very minute amounts can be used. Any type of pepper can be used, although red pepper or capsaicin is preferred.

Sulfur:

If used, it is preferred that sulfur be in an amount up to 1.0% with a more preferred range of 0.1 to 0.5%. The sulfur amount is controlled based on the desired odor emanation. Amounts less than about 0.25% sulfur are desired to maintain the odorless properties, with even less amounts such as up to 0.15%, up to 0.1% and up to 0.05% being even more preferred.

Diatomaceous Earth:

Diatomaceous earth can also be employed as part of the inventive composition in an effective amount to deter insects from landing on the treated area of the user. Given the sharp nature of the diatomaceous earth, insects find it irritating to come into contact with it. A preferred amount is at least 0.01% by weight with an upper limit being around 5.0% or where it because too difficult to apply such as by spraying. The diatomaceous earth can be any type that is readily available commercially.

Inert Ingredients:

The inventive composition also includes some inert ingredients in effective amounts as well. These inert ingredients include one or more emulsifiers to aid in emulsifying other ingredients in the composition. An effective amount of a skin emollient for assisting in the skin taking up the other ingredients is also included. The balance of the composition is water. An optional but effective amount of one or more preservatives can be employed as well.

In a preferred embodiment, the inert ingredients, in weight percent based on the total composition weight include:

One or More Emulsifiers:

Emulsifiers can be included in the composition in a range of 1-5.0%, and a preferred range of 1.5-3.0%. Sodium lauryl sulfate or Triton X-100, an octyl phenol ethoxylate, are preferred emulsifiers, but virtually any emulsifier or combination of emulsifiers could work. Other examples of emulsifiers include guar and xanthan gums, and various types of emulsifying polymers as would be known in the art.

Skin Emollient:

A skin emollient is used in a preferred amount of 0.05 to 1.0% with a more preferred range of 0.075 to 0.15%. A preferred emollient is glycerin, propylene glycol, or an equivalent.

Preservatives:

While the preservative can be used in an amount effective to preserve the formulation and resist bacterial growth, preferred ranges include from 0.10 to 1% by weight, more preferred ranges include 0.15% to 0.5% with a target of around 0.2-0.3%. Virtually any preservative can be employed in the formulation, with examples including those using propyl paraben, methyl paraben and diazolidinyl urea, e.g., Germaben II. Another specific preservative that can be used is Dantoguard® manufactured by Lonza, see www.Lonza.com.

Water:

Water is added as a balance of the composition.

While the active and inert ingredients are described in terms of effective amounts, one target formula of the invention would include about 4.3% oil, 0.027% capsaicin, 2.0% of a emulsifier such as TRITON X-100 or sodium lauryl sulfate, 0.1% glycerin, 0.2% of the Dantoguard preservative, with the balance water. Again though, it should be understood that these percentages could vary within the ranges set forth above.

It should be understood that the list of ingredients above is a preferred listing and other materials could be used in substitution or exchange. For example, other types of odorless oils such as soybean oil, castor oil, canola oil, corn oil, etc. could be used.

The sulfur can be present as elemental sulfur or in a compound form such as sodium sulfate or the like. Another skin emollient rather than glycerin could be used such as propylene glycol. While red pepper as capsaicin is preferred, other pepper varieties (black, white, etc) may also be used that have similar irritating characteristics.

The oil is desired to create a slick surface, which is undesirable from the insect's view point. Too little oil will not create this effect. Too much oil adds nothing to this effect, and may possibly dilute the effects of the other active and inactive ingredients. The pepper acts as an irritant to the insect. The glycerin acts as an emollient to make the repellant more acceptable to skin. The sulfur also has repellant properties. The emulsifier emulsifies the components in the aqueous base, particularly the active ingredients of pepper and sulfur.

Too much oil may also prevent spraying if this mode is used, but more oil could be used if a cream or lotion is used.

The present invention is an ideal insect repellant since it utilizes all natural components and is odorless. The lack of odor is important odor can be an attractant of insects. The odorless characteristic of the formulation is especially advantageous in hunting environments where insects tend to be prevalent. The insect repellant is highly effective during hunting since it does not introduce unwanted scents that could signal the presence of a potential predator to an animal. The repellant could be applied via a spray, using wipes or direct application as a liquid to one's skin. It could be used as a cream but with more oil and a wax or polymer to keep the components in suspension.

As such an invention has been disclosed in terms of preferred embodiments thereof, which fulfills each and every one of the objects of the invention as set forth above, and provides an improved odorless insect repellant and method of use.

Of course, various changes, modifications and alterations from the teachings of the present invention may be contemplated by those skilled in the art without departing from the intended spirit and scope thereof. It is intended that the present invention only be limited by the terms of the appended claims.

1) An aqueous odorless insect composition containing an effective amount of an odorless oil to create a slick surface to repel insects, an effective amount of pepper for insect repellency, an effective amount of one or more emulsifiers for emulsification of at least the amount of pepper, an effective amount of a skin emollient to enhance application of the composition onto a user's skin, with the balance being water.

2) The composition of claim 1, wherein the odorless oil is at least 1% by weight of the composition.

3) The composition of claim 1, wherein the pepper ranges up to 0.04% by weight of the composition.

4) The composition of claim 1, wherein the composition includes an effective amount up to 1.0% by weight of the composition of sulfur for insect repellency.

5) The composition of claim 1, wherein the skin emollient ranges from 0.05% to 1.0% by weight of the composition.

6) The composition of claim 1, wherein the emulsifier ranges from 1.0 to 5.0% by weight of the composition.

7) The composition of claim 1, further comprising a preservative in an effective amount for deterring bacterial contamination of the composition.

8) The composition of claim 1, wherein the odorless oil is at least 1% by weight of the composition, the pepper ranges up to 0.04% by weight of the composition, the emulsifier ranges from 1.0 to 5.0% by weight of the composition, and the skin emollient ranges from 0.05% to 1.0% by weight of the composition.

9) The composition of claim 1, wherein the odorless oil is mineral oil, the emulsifier is sodium lauryl sulfate or an octyl phenol ethoxylate, the pepper is capsaicin, and the skin emollient is glycerin or propylene glycol.

10) The composition of claim 8, wherein the odorless oil is mineral oil, the emulsifier is sodium lauryl sulfate or an octyl phenol ethoxylate, the pepper is capsaicin, and the skin emollient is glycerin or propylene glycol.

11) The composition of claim 2, wherein the odorless oil ranges between 3.0 and 5.0%.

12) The composition of claim 3, wherein the pepper ranges between 0.01 and 0.03%.

13) The composition of claim 4, wherein the sulfur ranges between 0.01 and 0.05%.

14) The composition of claim 5, wherein the skin emollient ranges between 0.05 and 1.0%.

15) The composition of claim 1, further including an effective amount of diatomaceous earth for repelling insects due to contact between the diatomaceous earth and a part or parts of the insect.

16. The composition of claim 15, wherein the diatomaceous earth ranges between 0.01% and 5.0% by weight of the composition.

17. The composition of claim 7, wherein the preservative ranges between 0.1% and 1.0% by weight of the composition.

18. In a method or repelling insects from human skin by applying an insect repellant composition to the skin, the improvement comprising applying the composition of claim 1 to the skin.
